(19) United States
(12) Patent Application Publication
(10) Pub. No.: US 2009/0305736 A1
(43) Pub. Date: Dec. 10, 2009

(54) MOBILE COMMUNCATION TERMINAL STATION AND TRANSMISSION POWER SETTING METHOD

(75) Inventors: Hiroo OMORI, Ichikawa-shi (JP); Yukihiko OKUMURA, Yokohama-shi (JP)

Correspondence Address: CROWELL & MORING LLP;INTELLECTUAL PROPERTY GROUP, P.O. BOX 14300, WASHINGTON, DC, 20044-4300, US

(73) Assignee: NTT DoCoMo, Inc., Chiyoda-ku (JP)

(21) Appl. No.: 12/477,587

(22) Filed: Jun. 3, 2009

(30) Foreign Application Priority Data
Jun. 4, 2008 (JP) 2008-147310

(51) Int. Cl. H04B 7/005

(52) U.S. Cl. 455/522

(57) ABSTRACT

A mobile communication terminal station is capable of transmitting a preamble part by use of optimal parameters for a moving speed of the mobile communication terminal station. The mobile communication terminal station is provided with a power ramping section. The power ramping section includes a moving state discrimination section for discriminating the moving state of the mobile communication terminal station and a power ramping transmission parameter selecting section for setting the transmission parameters in response to the moving state that has been discriminated. The preamble part indicating a transmission start of a message is transmitted to a base transceiver station, with the transmission parameters that have been set.

### BACKGROUND OF THE INVENTION

1. Field of the Invention

The present invention generally relates to mobile communication terminal stations and transmission power setting methods, in particular, to a mobile communication terminal station and a transmission power setting method for use in power ramping by transmitting a preamble part of data for setting a transmission power, in advance of transmitting data to a base transceiver station.

2. Description of the Related Art

At present, in a movable terminal station for communication (hereinafter, referred to as mobile communication terminal station), there is a technique for controlling a transmission power so as to transmit data (transmission data) by use of power ramping. The conventional technique for controlling the transmission power by use of power ramping is described in JP 2007-266733 A, for example.

Herein, “preamble part” represents a bit sequence, out of the transmission data, for indicating the start of communication on a data link, and “message part” represents information part, following the preamble part, that is a purpose of transmission.

In a random access method with the use of power ramping, for example, when a mobile communication terminal station transmits transmission data to a base transceiver station, the preamble part of the transmission data is transmitted in advance of the message part. The transmission is repeated until the mobile communication terminal station receives a signal (Acquisition Indicator) indicating permission of transmission of the message part from the base transceiver station. Such a transmission method is referred to as Slotted ALOHA together with high-speed acquisition indication.

FIG. 5 is a diagram illustrative of a specific method of power ramping. In the example illustrated, the preamble part is transmitted at regular intervals (represented by retransmission interval A in FIG. 5) by a certain number of times (represented by the number of retransmissions), while the transmission power is being increased from an initial transmission power by a certain value (represented by step width in FIG. 5). In addition, this transmission is set to be one unit and the preamble part is transmitted multiple number of times (represented by number of retransmission repeated times in FIG. 5) so as to set the transmission power of the message part.

Furthermore, an initial transmission power, step width, transmission interval, the number of retransmission times, and the number of retransmission repeated times are included in parameters of power ramping. The preamble part is transmitted by use of power ramping, while the parameters are being adjusted. Then, the transmission power of the message part is set based upon the transmission power corresponding to a signal for permitting transmission that has been transmitted from the base transceiver station. Such an operation allows the initial transmission power to be set at an optimum value, with which the base transceiver station is capable of receiving the initial transmission power of the message part in a sufficient manner and the mobile communication terminal station does not consume the power unnecessarily.

In recent years, however, there is a demand for use of mobile communication stations under a high-speed moving environment such as in a bullet train, in accordance with the spread of the mobile communication terminal stations. When the mobile communication terminal station moves at a high speed, the relative position of the mobile communication terminal station and the base transceiver station is drastically changed in a short period of time. The change in the relative position will change the amplitude or phase of the transmission data over time dues to Rayleigh Fading phenomenon, so the signal quality will be subject to change.

If the signal quality is changed, the detection accuracy of the preamble part in the base transceiver station is degraded, thereby making difficult the synchronization between the base transceiver station and the mobile communication terminal station. Also, the preamble part is retransmitted frequently, thereby causing problems that the amount of network (NW) resources consumed by the mobile communication terminal station is increased, and in addition, that the period of time until the transmission is permitted is longer.

These problems are solved by increasing the transmission power for the preamble part and enhancing the detection accuracy of the preamble part, in the base transceiver station. However, if the initial value of the transmission power for the preamble part is set at an excessive value, the consumed amount of the NW resources and the uplink interference amount will be great. Therefore, under the high-speed moving environment, the transmission of the preamble part has to be controlled in response to the moving speed of the mobile communication terminal station.

It should be noted, however, that the above-described conventional technique does not intend to use the mobile communication terminal stations under the high-speed moving environment. For this reason, power ramping is controlled for the conventional mobile communication terminal station by use of certain parameters set beforehand, regardless of the moving speed of the mobile communication terminal. The inventors of the present invention discovered that the consumption amount of the NW resources and the uplink interference amount are to be improved.

### SUMMARY OF THE INVENTION

The present invention has been made in view of the above circumstances and provides a mobile communication terminal station and a transmission power setting method, whereby a preamble part is transmitted by use of optimal parameter for a moving speed of the mobile communication terminal station.

According to an aspect of the present invention, there is provided a mobile communication terminal station comprising: a moving state discriminator 102 that discriminates a moving state of the mobile communication terminal station; a power ramping transmission parameter selector 104 that sets a transmission parameter used for power ramping in response to the moving state discriminated by the moving state discriminator.

With such a configuration, a transmission power for the preamble part is set in response to a moving speed of the mobile communication terminal station. Accordingly, the transmission parameter optimal for the moving speed of the mobile communication terminal station is set and a mobile communication terminal station that is capable of transmitting the preamble part by use of the parameters optimal for the moving speed of the mobile communication terminal station is provided.

In the above configuration, the transmission parameter includes at least a transmission power. With such a configuration, the initial transmission power may be set in consideration of the moving speed of the mobile communication terminal station, and the transmission power is set by successively increasing the transmission power from the initial transmission power. Therefore, an appropriate initial transmission power is set in a relatively short period of time with the number of transmission times of the preamble part suppressed.

In the above configuration, the transmission parameter may further include an initial transmission power for a first transmission, and the power ramping transmission parameter selector may select a greater value for the initial transmission power, when the moving speed of the mobile communication terminal station indicated by the moving state is higher. With such a configuration, in a case of predicting that the moving speed of the mobile communication terminal station is great and the communication state is unstable, the initial transmission power is set to be great so that an appropriate transmission power is set with the number of transmission times of the preamble part suppressed.

In the above configuration, data may be transmitted by use of the power ramping a plurality of times, and the transmission parameter may further includes a difference in the transmission power between data successively transmitted, a difference in transmission intervals, the number of data transmission times. With such a configuration, multiple transmission parameters are further set in response to the moving speed, thereby permitting setting of transmission conditions suitable for the moving speed.

According to another aspect of the present invention, there is provided a transmission power setting method comprising: discriminating a moving state of a mobile communication terminal station (S401); setting a transmission parameter used for power ramping in response to the moving state discriminated (S403). With such a configuration, a transmission power for the preamble part is set in response to a moving speed of the mobile communication terminal station. Accordingly, the transmission parameter optimal for the moving speed of the mobile communication terminal station is set and a transmission power setting method that is capable of transmitting the preamble part by use of the parameters optimal for the moving speed of the mobile communication terminal station is provided.

A mobile communication terminal station and a transmission power setting method according to aspects of the present invention as described above are capable of setting transmission parameters in consideration of a moving speed of the mobile communication terminal station. This allows the provision of the mobile communication terminal station and transmission power setting method, whereby the consumed amount of NW resources and interference amount are further reduced and a preamble part is transmitted by use of parameters optimal for the mobile communication terminal station that is moving.

### BRIEF DESCRIPTION OF THE DRAWINGS

FIG. 1 illustrates a communication system including a mobile communication terminal station according to an aspect of the present invention;

FIG. 2 illustrates a functional block diagram of a power ramping transmission parameter selecting section illustrated in FIG. 1;

FIG. 3 illustrates transmission parameters stored in a power ramping transmission parameter storing section;

FIG. 4 is a flowchart illustrative of the operation of a mobile telephone according to an aspect of the present invention; and

FIG. 5 is a diagram illustrative of power ramping specifically.

### DETAILED DESCRIPTION OF THE PREFERRED EMBODIMENTS

A mobile communication terminal station and a communication power setting method according to an embodiment of the present invention will now be described with reference to the drawings.

### (Overall System Configuration)

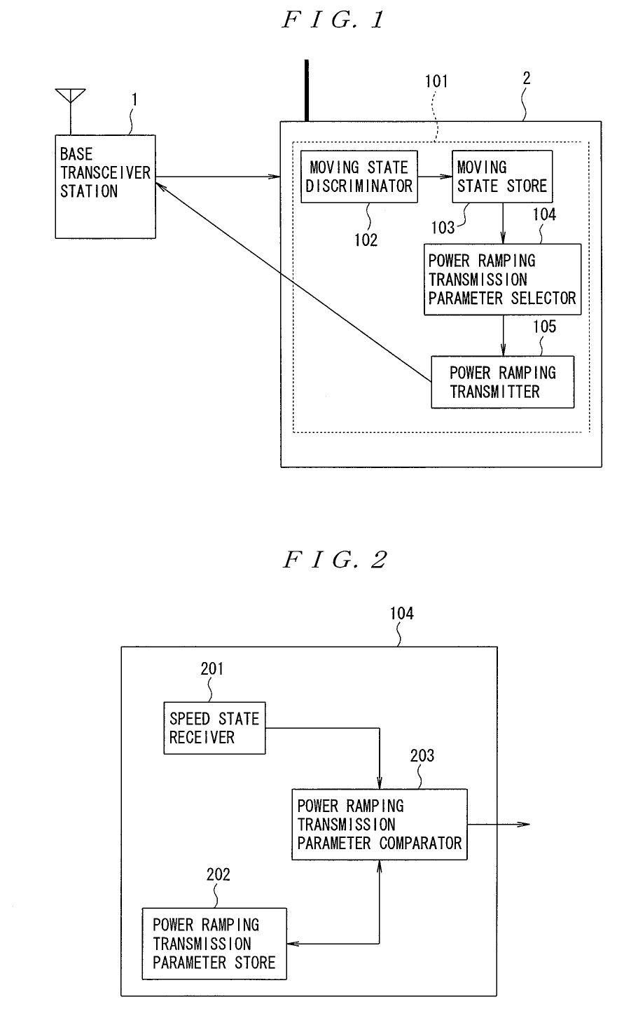

FIG. 1 illustrates a communication system including a mobile communication terminal station according to an aspect of the present invention. As illustrated, the communication system according to an aspect of the present invention includes: a mobile communication terminal station 2; and a base transceiver station 1 for transmitting and receiving data to and from the mobile communication terminal station 2. According to the present embodiment, in order to focus attention on data to be transmitted to the base transceiver station 1 from the mobile communication terminal station 2, the data transmitted to the base transceiver station 1 from the mobile communication terminal station 2 is referred to as transmission data. In addition, the transmission data includes: a message part indicating information to be transmitted; and a preamble part indicating a transmission start of the message part.

The base transceiver station 1 is connected to a mobile switching center via a base transceiver station controller, not shown. The base transceiver station 1 receives the transmission data from the mobile communication terminal station 2, and then transmits the transmission data to another mobile communication terminal station, not shown, via the mobile switching center or the like. Herein, a range where radio waves transmitted by the base transceiver station 1 reach is referred to as cell.

The mobile communication terminal station 2 is provided with a power ramping section 101 for transmitting the preamble part, while changing transmission parameters that are transmission conditions of the preamble part. The transmission parameters denote the transmission conditions for the preamble part. Also, power ramping denotes processing of repeatedly transmitting the preamble part, while changing the transmission electricity (power).

The power ramping section 101 includes: a moving state discriminator 102 for discriminating the moving state of the mobile communication terminal station 2; a moving state store 103 for successively storing information relating to the moving speed; a power ramping transmission parameter selector 104 for selecting a transmission parameter to be set in response to the moving state discriminated by the moving state discriminator 102; and a power ramping transmitter 105 for transmitting the preamble part to the base transceiver station 1 by use of the transmission parameter selected by the power ramping transmission parameter selector 104.

In the above configuration, for example, the moving state discriminator 102 is capable of measuring a momentary value of a radio wave (hereinafter, referred to as radio signal) transmitted from the base transceiver station 1, and counting the number of level drops of the radio signal per unit time with the use of the momentary value. The “level drop” means a phenomenon caused by the Rayleigh fluctuations of a radio signal, and dropping of the level of the radio signal at intervals of approximately half wavelength thereof.

According to the moving state discriminator 102 as described above, a moving speed v of the mobile communication terminal station 2 is obtainable by the following expression, where λ represents a wavelength of a radio signal, t represents a unit time, n represents the number of level drop times per unit time.

V=(n·λ/2)/t

The moving state discriminator 102 repeatedly receives the radio signal that has been transmitted from the base transceiver station, and then repeatedly calculates the moving speed v of the mobile communication terminal station 2 with the above expression. The calculated moving speed is successively stored in the moving state store 103. The moving state store 103 according to the present embodiment stores a counted number n of the level drops.

However, the moving state discriminator 102 according to the present embodiment is not limited to the above configuration. In other words, the moving state discriminator 102 is not limited to the configuration for detecting the moving speed of the mobile communication terminal station 2 by use of the level drop, but may have, for example, a Global Positioning System (GPS) function provided in the mobile communication terminal station 2.

In addition, the moving state discriminator 102 may calculate the moving speed of the mobile communication terminal station 2 by use of changeover of cell where the mobile communication terminal station 2 exists. When the moving speed is detected by the changeover of cell, the notified information transmitted from the base transceiver station 1 is configured to include information indicating the position of the mobile communication terminal station 2. In this configuration, the mobile communication terminal station 2 is capable of detecting not only the changeover of cell but also the distance that the mobile communication terminal station 2 moved within a given period of time.

Furthermore, the mobile communication terminal station 2 receives a signal transmitted from a single antenna, so that the moving state discriminator 102 may calculate the moving speed of the mobile communication terminal station 2 with a phasing pitch.

Moreover, the present embodiment is not limited to the configuration in which the mobile communication terminal station 2 has the moving state discriminator 102, but the base transceiver station 1 may discriminate a moving state or a speed state of the mobile communication terminal station 2. If this configuration is employed, the moving state discriminator 102 of the mobile communication terminal station 2 acquires information relating to the moving state or the speed state of the mobile communication terminal station 2 from the base transceiver station 1, and then discriminates the moving state or the speed state of the mobile communication terminal station 2 based upon the acquired information. If the base transceiver station 1 discriminates the moving state or the speed state of the mobile communication terminal station 2, a conceivable example is that the base transceiver station 1 receives the signal transmitted from the mobile communication terminal station 2 and calculates the moving speed of the mobile communication terminal station 2 with its phasing pitch.

### (Configuration Example of Power Ramping Transmission Parameter Selecting Section)

FIG. 2 illustrates a functional block diagram of the power ramping transmission parameter selector 104 illustrated in FIG. 1. The power ramping transmission parameter selector 104 includes: a speed state receiver 201; a power ramping transmission parameter store 202; and a power ramping transmission parameter comparator 203.

The speed state receiver 201 loads a moving speed stored in the moving state store 103 so as to pass the moving speed to the power ramping transmission parameter comparator 203. The power ramping transmission parameter store 202 is storage such as a memory storing the transmission parameters for the preamble part.

The moving speed is input into the power ramping transmission parameter comparator 203 via the speed state receiver 201. Then, the power ramping transmission parameter comparator 203 compares the moving speed taken with the transmission parameters stored in the power ramping transmission parameter store 202, and selects the transmission parameters corresponding to the moving speed. After that, the power ramping transmission parameter comparator 203 outputs the selected transmission parameter to the power ramping transmitter 105.

### (Example of Transmission Parameter)

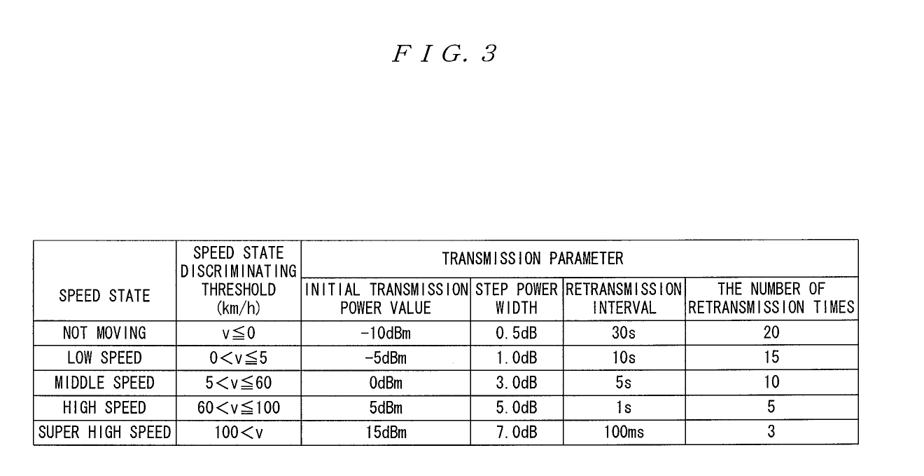

FIG. 3 illustrates transmission parameters stored in the power ramping transmission parameter store 202. According to the present embodiment, as illustrated, an initial transmission power value, step power width, retransmission interval, and the number of retransmission times are set as the transmission parameters. Each of the transmission parameters is associated with each speed state of “not moving”, “low speed”, “middle speed”, “high speed”, and “super high speed”. The above each speed state is determined by the moving speed v of the mobile communication terminal station 2.

The speed state indicates that the mobile communication terminal station 2 moves faster in the order of “not moving”, “low speed”, “middle speed”, “high speed”, and “super high speed”. According to the present embodiment, the transmission parameter is configured such that a greater value should be selected as an initial transmission power, when the moving speed of the mobile communication terminal station 2 is higher. In addition, according to the present embodiment, as the moving speed of the mobile communication terminal station 2 becomes faster, the step power width is set to be greater, the retransmission interval is set to be shorter, and the number of retransmission times is set to be smaller. Such settings are made, because the signal quality of the transmission data is greatly fluctuated in a short period of time, as the mobile communication terminal station 2 moves at a high speed.

Referring to FIG. 3, in a case where the moving speed v of the mobile communication terminal station 2 is, for example, higher than 5 km/h and lower than 60 km/h, the moving speed of the mobile communication terminal station 2 is determined to be “middle speed”. In this case, the power ramping transmission parameter selector 104 selects “0 dBm” for the initial transmission power, “3.0 dB” of the step power width, “5 s” of the retransmission interval, and “10” of the number of retransmission times, so as to correspond to the “middle speed”.

In this sense, the initial transmission power denotes a transmission power of the preamble part to be firstly transmitted out of the preamble parts to be transmitted multiple number of times. Incidentally, “dBm”, which is a unit of the initial transmission power, denotes a power ratio with 1 mW set at 0 dBm. The step power width 3.0 dB represents the ratio of the power with respect to the initial transmission power.

### (Operation of Power Ramping Transmission Parameter Comparing Section)

The power ramping transmission parameter comparator 203 outputs the selected transmission parameters to the power ramping transmitter 105, based upon FIG. 3. The power ramping transmitter 105 transmits the preamble part according to the transmission parameters that have been output. That is to say, in a case where the moving speed of the mobile communication terminal station 2 is “middle speed”, the power ramping transmitter 105 sets the initial transmission power at 0 dBm, and then transmits the preamble part repeatedly, while increasing the set value every time by 3.0 dB. The time interval between one transmission of a certain preamble part and next transmission (retransmission) thereof is 5 seconds, and the number of retransmission times is 10.

Additionally, according to the present embodiment, as described heretofore, the moving state discriminator 102 repeatedly calculates the moving speed of the mobile communication terminal station 2. The calculated moving speeds are successively input into the power ramping transmission parameter selector 104, so that the power ramping transmission parameter selector 104 selects the transmission parameters based upon the moving speed that has been input.

At this time, the power ramping transmission parameter comparator 203 compares the moving speed input from the speed state receiver 201 with a previously-input moving speed. Then, when the both values are same, subsequent processes will not be executed. When a currently-input moving speed and the previously-input moving speed are different, the power ramping transmission parameter comparator 203 selects the transmission parameters corresponding to the currently-input moving speed.

The selected transmission parameters are output to the power ramping transmitter 105. The power ramping transmitter 105 transmits the preamble part by use of the selected transmission parameters. As a result, when the moving speed of the mobile communication terminal station 2 is changed, it is possible to change the transmission parameters so as to correspond to the change and update the previous transmission parameters with the changed transmission parameters.

It should be noted that the present embodiment is not limited to the above-described configuration. For example, as to the transmission parameters, all of the initial transmission power, step power width, retransmission interval, and the number of retransmission times are not limited to those associated with the speed state, but at least the initial transmission power may be associated with the speed state.

### (Details of Power Ramping Transmission Processing)

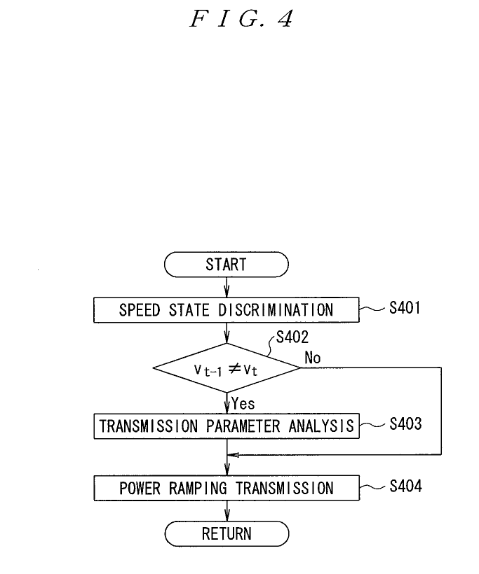

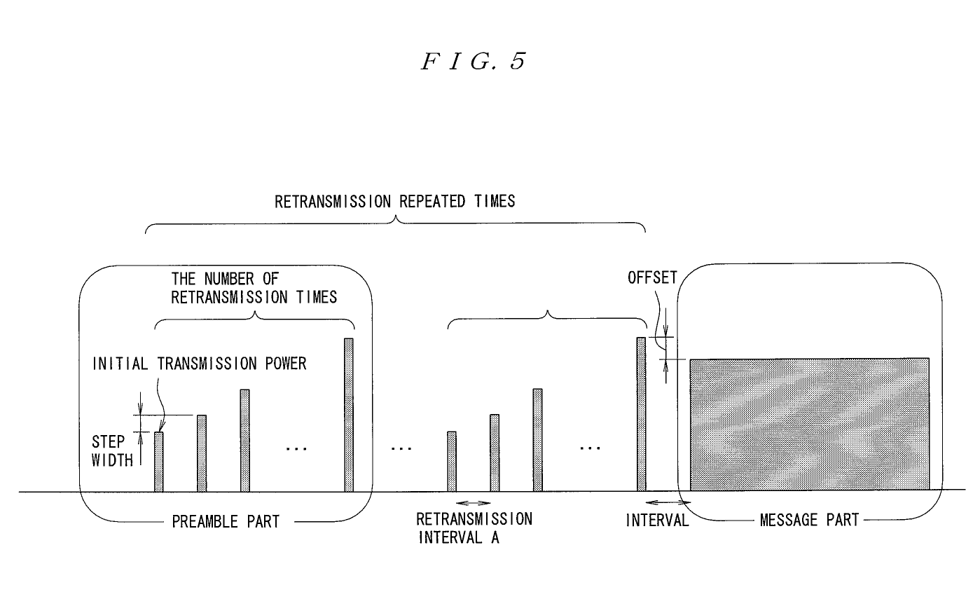

FIG. 4 is a flowchart illustrative of the operation of the mobile communication terminal station 2 with the above-described configuration. The mobile communication terminal station 2 firstly discriminates the moving speed of the mobile communication terminal station 2 as a speed state so as to detect the moving speed of the mobile communication terminal station 2 (step S401). According to the present embodiment, a radio signal transmitted from the base transceiver station 1 is received for the discrimination of the moving speed. Then, the mobile communication terminal station 2 counts the number of level drops of the radio signal. Subsequently, the mobile communication terminal station 2 also determines whether or not the range of the speed state, in which a currently-input (t-th time) moving speed vt of the mobile communication terminal station 2 is included (the range of speed such as low speed or high speed, as illustrated in FIG. 3), and that of the speed state, in which a previously-input ((t−1)-th time) moving speed v(t−1) of the mobile communication terminal station 2 is included are different (step S402).

The receipt of the radio signal is a necessary process, according to the present embodiment, in a case of detecting the moving speed by receiving the radio signal transmitted from the base transceiver station. If the moving speed is detected by use of another method, a necessary process will be executed for detecting the moving speed in another method instead of the receipt of the radio signal.

As a result of the determination in step S402, when the range of the speed state including the moving speed vt and that of the speed state including the moving speed v(t−1) are same (step S402: No), the power ramping transmitter 105 transmits the preamble part by use of power ramping, without changing the transmission parameters (step S404).

Meanwhile, when the range of the speed state including the moving speed vt and that of the speed state including the moving speed v(t−1) are different (step S402: Yes), the power ramping transmission parameter comparator 203 compares the moving speed vt with the transmission parameters stored in the power ramping transmission parameter store 202. subsequently, the power ramping transmission parameter comparator 203 selects the transmission parameters corresponding to the moving speed vt (step S403: transmission parameter analysis). The power ramping transmitter 105 transmits the preamble part by use of power ramping (step S404).

Moreover, the above processing is repeated whenever the mobile communication terminal station 2 receives a radio signal from the base transceiver station.

### (Conclusion)

According to the present embodiment discussed heretofore, it is possible to transmit the preamble part by use of power ramping in consideration of the moving speed of the mobile communication terminal station 2. This allows the increase in the initial transmission power, when the mobile communication terminal station 2 is moving at a high speed and the base transceiver station 1 hardly receives the preamble part. It is therefore possible to suppress the number of retransmission times of the preamble part and thereby to suppress the consumption of NW resources.

Conversely, when the mobile communication terminal station 2 is moving at a low speed and the base transceiver station 1 readily receives the preamble part, the initial transmission power is suppressed at a relatively low value, thereby avoiding the increase in the uplink interference amount. This also prevents the mobile communication terminal station 2 from consuming the power more than necessary for the transmission of the transmission data.

The present embodiment is not limited to the above-described configuration. That is to say, the setting parameters may be set for every certain threshold with the use of a predefined table, as illustrated in FIG. 3, or may be decided by a calculating formula. An example is −10+v×25/100 is conceivable, as a calculating formula for calculating the initial transmission power value. Another example may be a combination of a table and a calculating formula for parameter settings such that a calculating formula is employed for the moving speed 50 km or less and a table for setting the parameters for every threshold is employed for the moving speed 50 km or more.

What is claimed is:

1. A mobile communication terminal station comprising:
a moving state discriminator that discriminates a moving state of the mobile communication terminal station;
a power ramping transmission parameter selector that sets a transmission parameter used for power ramping in response to the moving state discriminated by the moving state discriminator.

2. The mobile communication terminal station according to claim 1, wherein the transmission parameter includes at least a transmission power.

3. The mobile communication terminal station according to claim 2, wherein:
the transmission parameter further includes an initial transmission power for a first transmission, and
the power ramping transmission parameter selector selects a greater value for the initial transmission power, when the moving speed of the mobile communication terminal station indicated by the moving state is higher.

4. The mobile communication terminal station according to claim 3, wherein:
data is transmitted by use of the power ramping a plurality of times, and
the transmission parameter further includes a difference in the transmission power between data successively transmitted, a difference in transmission intervals, the number of data transmission times.

5. A transmission power setting method comprising:
discriminating a moving state of a mobile communication terminal station;
setting a transmission parameter used for power ramping in response to the moving state discriminated.
